(19) United States
(12) Patent Application Publication
(10) Pub. No.: US 2006/0197835 A1
(43) Pub. Date: Sep. 7, 2006

(54) Wrist-attached display system for unmanned vehicle imagery and communication

(76) Inventors: Robert C. Anderson, Cumming, GA (US); Jerome S. Conway, Suwanee, GA (US); David C. Huffman, Norcross, GA (US); Keith I. Tognoni, Duluth, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/072,104

(22) Filed: Mar. 4, 2005

(51) Int. Cl. H04N 7/18; H04N 7/00; H04N 9/47

(52) U.S. Cl. 348/117

(57) ABSTRACT

A display system includes a wristwatch-sized device that a user, such as a soldier on a battlefield, can wear, a data receiver, and a small video display. The device can receive data, such as video or still digital imagery captured by an unmanned aerial vehicle (UAV) in flight or unmanned ground vehicle, and display it in real-time for the user to view.

### BACKGROUND OF THE INVENTION

1. Field of the Invention

The present invention relates generally to electronic displays and, more specifically, to receiving and displaying video imagery on a wearable display device.

2. Description of the Related Art

Unmanned air and ground vehicles have been developed for use by military and industrial entities. For example, a military unmanned aerial vehicle (UAV) is a small aircraft that carries sensors and communications equipment for reconnaissance and surveillance. Personnel on the ground at a ground control station (GCS) can control and fly the UAV by transmitting instructions via a radio communication link. A primary feature of many UAVs is that they can gather and transmit data to the GCS via the communication link in real-time. Some UAV systems include additional ground-based receivers. Sensors for gathering such data commonly include visible and infrared video cameras. When flown over a battlefield, for example, personnel manning the GCS or other ground-based receiver can view video imagery from the UAV showing the battlefield action or terrain. In some UAV systems, the video imagery is displayed on a dedicated laptop computer associated with the GCS or other ground-based receiver. Using a UAV in this manner provides valuable reconnaissance and surveillance information in real-time at relatively low cost and with minimal risk of loss of life or expensive equipment.

Two steps are involved in utilizing the data received from a UAV. First, personnel operating the GCS must receive the data from the UAV. Then, such personnel disseminate the data or relevant information extracted from the data to individual soldiers in the field, typically through a chain-of-command. Soldiers in the field may use this information to plan tactical maneuvers and determine the locations of enemy troops, targets and battlefield features. However, communication delays in getting this data from the UAVs to the front-line soldiers who need the data can render the data untimely. Thus, it would be desirable to minimize the delay in disseminating the information.

The term “network-centric warfare” has been used to describe a system in which information is electronically exchanged among units locally involved in a military operation instead of always requiring that all data be routed through central command first. For example, military personnel on the battlefield may carry portable laptop computers that are wirelessly networked to one another. The information exchanged between networked computers may include text and images.

Accordingly, it would be desirable to improve the efficiency with which visual information is disseminated to and shared among units involved in an operation. It is to such a method and apparatus that the present invention is primarily directed.

### SUMMARY OF THE INVENTION

An imagery display system includes a device or apparatus that a user, such as a soldier, airman, seaman, or other user involved in a coordinated military or industrial operation, can wear on his or her wrist. The device includes a wristwatch-like housing and a small video display. The device can receive data, such as video or still digital imagery captured by an unmanned aerial vehicle (UAV) in flight or unmanned ground vehicle, and display it in real-time for the soldier to view.

The system optionally can include a global positioning system (GPS) receiver. The GPS receiver enables the device to indicate the user's location on the display. For example, an icon representing the soldier can be superimposed upon a map.

The system may include a camera, preferably mounted on the wrist device, for capturing still or moving images. Optionally, the camera can be fitted with infrared or low-light (nightvision) imaging systems.

The system may include a wireless networking transceiver for communicating data with other such imagery display systems in the field, with conventional portable computers, or other equipment. A user interface suitable for text-messaging can be included to enable users to exchange text messages. In embodiments of the invention in which a camera is included, camera images can be exchanged with other systems. The combination of text-messaging and capturing video imagery with the camera enables a form of videoconferencing to be conducted. Still images that the user selects for capture from the unmanned vehicle transmissions can also be exchanged.

### BRIEF DESCRIPTION OF THE DRAWINGS

FIG. 1 illustrates an imagery display device according to a preferred form of the invention, the imagery display device worn by a user and provided for displaying video imagery transmitted from an unmanned aerial vehicle (UAV).

FIG. 2 illustrates an imagery display system according to another form of the invention, the system provided for receiving and displaying video imagery transmitted from a UAV in accordance with one embodiment of the invention.

FIG. 3 illustrates an imagery display system receiving and displaying video imagery transmitted from a UAV.

FIG. 4 is a perspective view of a wrist-attachable imagery display device having touch-screen-based user controls.

FIG. 5A is a perspective view of an alternative wrist-attachable imagery display device having a clamshell structure with pushbutton-based user controls, showing the device in an open position.

FIG. 5B is a perspective view of the device of FIG. 5A in a partially closed position.

FIG. 6A is a perspective view of another alternative wrist-attachable imagery display device having a clamshell structure with miniature keyboard-based user controls, showing the device in an open position.

FIG. 6B is a perspective view of the device of FIG. 6A in a partially closed position.

FIG. 7 is a schematic block diagram of the imagery display device shown in FIG. 3.

FIG. 8 is flow diagram illustrating an exemplary method of operation of the imagery display device of the embodiment shown in FIGS. 3 and 7.

### DETAILED DESCRIPTION

In the following description, like reference numerals indicate like components to enhance the understanding of the invention through the description of the drawings. Also, although specific features, configurations and arrangements are discussed below, it should be understood that such is done for illustrative purposes only. A person skilled in the relevant art will recognize that other steps, configurations and arrangements are useful without departing from the spirit and scope of the invention.

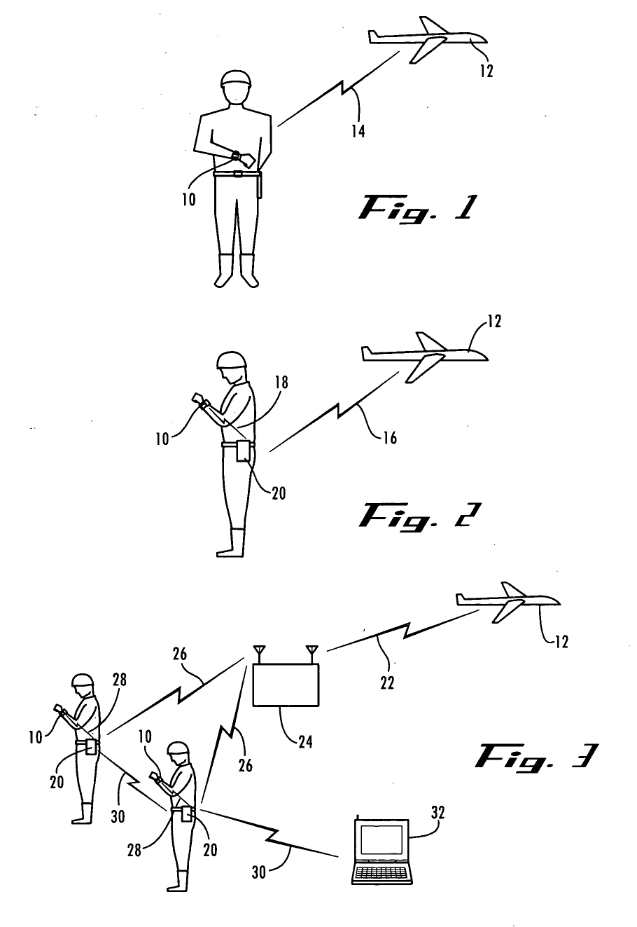

As illustrated in FIG. 1, an imagery display system includes an imagery display device 10, worn on the wrist of a soldier or other user in the manner in which a conventional wristwatch is worn. Device 10 thus includes a suitable strap, bracelet or similar means conventionally used for attaching a wristwatch or similar object to a user's wrist or nearby portion of the arm. The system can receive data from an unmanned aerial vehicle (UAV) 12 via one or more communication links 14. The UAV data can include still or video imagery.

UAV 12 can be any suitable UAV of the type conventionally used by the military to gather and transmit imagery to personnel on the ground. Its construction and operation are known in the art and therefore not described in further detail herein. It should be noted that although in the illustrated embodiment of the invention the transmissions originate with a UAV, in other embodiments they can originate with any other suitable source, such as an unmanned ground vehicle or other vehicle.

As illustrated in FIG. 2, in some embodiments of the invention the communication of data between UAV 12 and imagery display device 10 can be indirect, via, for example, a first communication link 16 and a second communication link 18. In such embodiments, the imagery display system can include, in addition to imagery display device 10, an auxiliary device 20, worn by the user in a convenient manner, such as by clipping or otherwise attaching it to the user's belt or by carrying the auxiliary device 20 in a backpack. Auxiliary device 20 receives the data from UAV 12 via first communication link 16 and, in turn, transmits or relays that data or a portion thereof to imagery display device 10 via second communication link 18.

As illustrated in FIG. 3, in other embodiments of the invention the communication of data between imagery display device 10 and UAV 12 can be via a first communication link 22 between UAV 12 and a ground-based receiver 24, a second communication link 26 between ground-based receiver 24 and auxiliary device 20, and a third communication link 28 between auxiliary device 20 and imagery display device 10. Ground-based receiver 24, which may be a portable device remotely located from the soldier on the battlefield, receives data from UAV 12 via first communication link 22 and, in turn, transmits the data to auxiliary device 20 via second communication link 26. Auxiliary device 20 in turn transmits that data or a portion thereof to imagery display device 10 via third communication link 28. Note that more than one user can receive and view the data transmitted by UAV 12.

The imagery display systems, according to the invention, carried by soldiers or other users can be part of a wireless network in which they can communicate with one another and with other devices, such as laptop computers 32, via additional communication links 30, in keeping with the network-centric warfare philosophy of today's military.

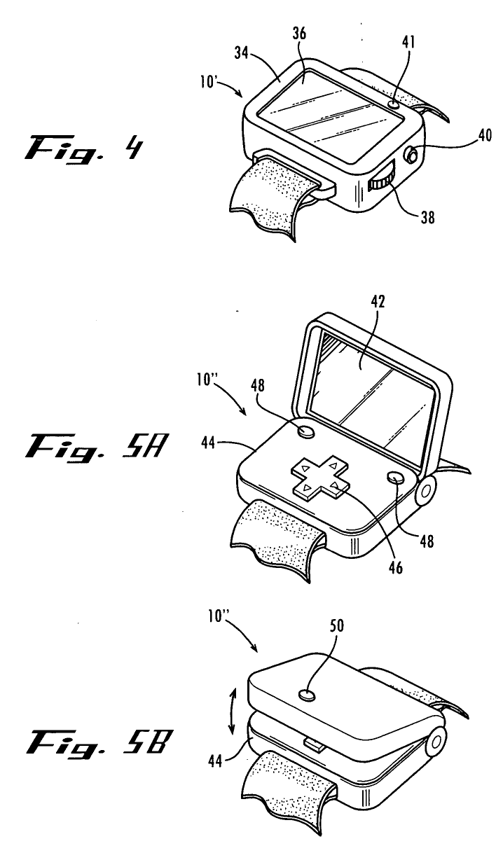

As illustrated in FIGS. 4-6, embodiments of imagery display device 10 can have any of a number of suitable user interface schemes. For example, in one such embodiment, an imagery display device 110 has a wristwatch-like housing 34, a touch-screen display 36 of the LCD, OLED or other suitable type, and suitable user input controls such as a thumbwheel 38 and one or more buttons 40. The user interface can operate similarly to the way in which some conventional personal digital assistant (PDA) and handheld computer user interfaces operate for example, menu options are displayed on touch-screen display 36, and the user can select one of the menu options by touching the appropriate area of display 36 with a finger or stylus pen (not shown), by rotating thumbwheel 38, by pressing buttons 40, or by some combination thereof. In addition, a camera 41 is mounted in housing 34, which camera can be of the miniature CCD-based type conventionally included in some mobile telephones and similarly compact devices. In use, camera 41 can take still or video images of the user or other subjects at which the user points camera 41 by orienting his or her wrist.

In another embodiment, illustrated in FIGS. 5A-B, an imagery display device 210 has what is sometimes referred to as a “clamshell” structure. A user can access the screen 42, which is disposed in an upper portion of the housing 44, by flipping housing 44 open at a hinged connection between the upper portion and a fixed or lower portion of housing 44. As in the embodiment described above, screen 42 can be of the LCD, OLED or other suitable type known in the art. Imagery display device 210 also includes suitable user input controls, such as a 4-way directional button 46 and other buttons 48. The user interface can operate in essentially the same manner as in the embodiment described above: Menu options are displayed on screen 42, and the user can select one of the menu options using buttons 46 and 48. In addition, a camera 50 is disposed in the movable portion of housing 44 opposite screen 42, which facilitates capturing images when housing 44 is in the open position.

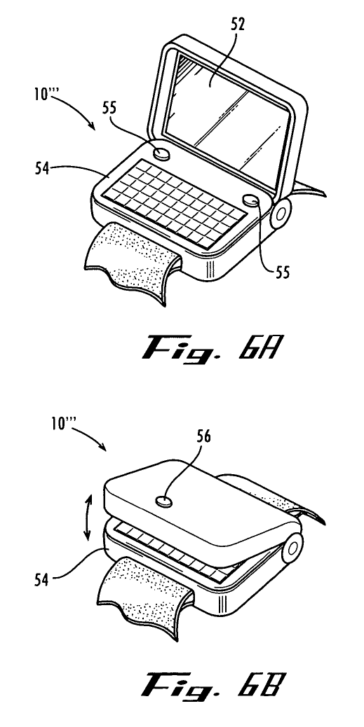

In yet another embodiment, illustrated in FIGS. 6A-B, an imagery display device 310 has a similar clamshell structure in which a user can access the screen 52 in an upper portion of the housing 54 by flipping it up with respect to the lower portion of housing 54. Imagery display device 310 also includes a miniature alphanumeric text keyboard 54 as one of its user input controls. Screen 52 can be of any of the above-mentioned types. Other user input controls can include one or more buttons 55. This type of user interface is particularly useful for text messaging, described in further detail below. As in other embodiments described above, menu options are displayed on screen 52, and the user can select one of the menu options using keyboard 54 or buttons 55. A camera 56 is also included in this embodiment.

It should be noted that the embodiments of the imagery display device described above are intended to be merely exemplary with regard to the user interface features. Although in each embodiment the imagery display device has a screen for viewing imagery, menu options and other data, and a combination of user input controls, in other embodiments (not shown), the imagery display device can have any other suitable combination of the user input controls described above, such as buttons, a touch-screen interface, a thumbwheel, and a keyboard, and any other user interface controls conventionally included in PDAs, handheld computers, mobile telephones, and the like.

As illustrated in FIG. 7, the display screen of imagery display device 10 is electronically coupled to the UAV data receiver 60 of auxiliary device 20 via a number of elements, including, in imagery display device 10, a display interface 62, a processor system 64, and a display device transceiver 66, and, in auxiliary device 20, a similar auxiliary device transceiver 68 and processor system 70.

Processor systems 64 and 70 include a suitable processing unit and associated program and data memory and interface circuitry. Processor systems 64 and 70 are programmed to perform suitable data encryption and decryption to ensure the security of the various communication links described herein. As described above with regard to FIGS. 2-3, in some embodiments of the invention, UAV data receiver 60 receives data directly from UAV 12, and in other embodiments it receives data relayed to it via ground-based receiver 24. Processor system 70 controls UAV data receiver 60 and auxiliary device transceiver 68 such that UAV data receiver 60 receives the UAV data, and auxiliary device transceiver 68 relays the data or a portion thereof to imagery display device 10 worn on the user's wrist. Although in the illustrated embodiment this display communication link between auxiliary device 20 on the user's belt and imagery display device 10 on the user's wrist is a wireless, radio-frequency (RF) link, in other embodiments it can be hard-wired, infrared or of other suitable type. Similarly, although in the illustrated embodiment some of these electronic elements are described as being disposed within imagery display device 10 and others within auxiliary device 20, they are part of the same imagery display system, and in other embodiments they can be apportioned or distributed between the two devices (or more or fewer devices) in any other suitable manner. For example, essentially all of the processing power, memory, and supporting elements can be located within auxiliary device 20, with imagery display device 10 containing little or no processing power—essentially containing only the display and associated interfaces and transceivers needed to provide a communication link with auxiliary device 20. In such embodiments, display device 10 functions as little more than a miniature data terminal, with some controls for input and the display screen for output. Conversely, with sufficient miniaturization, it is contemplated that all or essentially all such electronics, interfaces, transceivers and associated antennas, etc., could be disposed within imagery display device 10, with few or no such elements external to device 10.

Imagery display device 10 also includes a user control interface 72 and a camera interface 74 in the illustrated embodiment of the invention. User control interface 72 interfaces processor system 64 with the user input controls. As described above, the user input controls can include some or all of the following: buttons, a touch-screen, a thumbwheel, a keyboard, and any other user interface controls that are known in the art to be useful in PDAs, handheld computers, mobile telephones, and the like. Camera interface 74 interfaces processor system 64 with a camera, as described above with regard to FIGS. 5-6. Processor system 64 can control the capture of images by the camera and store them in its memory or control their transmission to a remote location via auxiliary device 20, as directed by the user.

In the illustrated embodiment, auxiliary device 20 further includes a wireless data network transceiver 76 and a Global Positioning System (GPS) receiver 78. Wireless data network transceiver 76 enables communication of still or video imagery, text messages, position coordinates, and other data between two auxiliary devices 20, or between auxiliary device 20 and other devices in the local area, such as portable computers (see FIG. 3) of the types conventionally used in network-centric warfare. GPS receiver 78 is a well-known element that uses signals received from a constellation of Earth-orbit satellites (not shown) to compute the geographic position coordinates (i.e., latitude and longitude) at which the signals are received. Processor system 70 can cause the user's position to be determined in this manner and transmitted to imagery display device 10 for display on the screen. Many commercially available GPS receivers commonly include pre-stored digital map information and can display an indication of the user's geographic position (e.g., an icon) graphically overlaid onto a map. In a similar manner, processor system 70 or processor system 64 can include pre-stored map information that it can use to display an indication of the user's position overlaid onto a map. In addition, in embodiments of the invention in which the UAV data includes not only imagery but also data indicating the geographic position of the UAV at the time the imagery was gathered, imagery display device 10 can also display an indication of the UAV's position overlaid on a map. Thus, the user can determine his or her position with respect to the UAV's position.

As illustrated in FIG. 8, exemplary methods of operation of the invention can include steps 80-92 of: (80) a user wearing device 10; (82) viewing still or video imagery gathered by the UAV; (84) displaying maps with indications of positions of the user and UAV; (86) sending and receiving text messages; (88) capturing still images or short video clips; (90) videoconferencing; and (92) digitally manipulating the imagery. These methods of operation and others can be effected by means of appropriate programming of processor systems 64 and 70 (FIG. 7).

The user interface can present these steps or others to the user as menu options on the display screen. The user can select any of them, in any order. For example, if the user selects the option of viewing UAV video imagery, the system receives the UAV data as described above and displays the video imagery on the screen. The user can thereby view the area over which the UAV is flying in real-time or near-real-time, in essentially the same manner in which personnel conventionally have viewed such imagery using prior ground-based receivers.

If the user selects the option of displaying maps, the system uses the GPS information to compute the user's position, receives the UAV's position, and displays icons or other indications overlaid on a graphical map to indicate the user's and UAV's positions with respect to the map.

If the user selects text messaging, the user can type in a text message on a keyboard if one is included in the embodiment, or by navigating through menus that allow the user to select text characters individually, or through pen-stroke recognition on a touch-screen in embodiments having a touch-screen. The system then encrypts and transmits the text message to a recipient, such as another soldier wearing another device 10. Similarly, the user can receive, decrypt and view text messages from other users of devices 10 or from personnel at remote command posts (e.g., via laptop computer 32 in FIG. 3).

With regard to videoconferencing, a soldier in the field can not only receive orders from a superior officer via the text-messaging feature, but the soldier and superior can view each other's faces while text-messaging each other as an aid to ensuring comprehension. Similarly, the soldier can quickly capture still images or short video clips on the battlefield and transmit them to his superiors or others.

Other options the user can select relate to manipulating the imagery. For example, the user can cause the system to store portions of UAV imagery, such as still images or short video segments or clips, in memory for later review. The user can also retrieve stored still images and annotate them with icons to indicate, for example, targets and other features of interest. With the wireless networking feature, the user can share annotated imagery with others.

It should be noted that, although in the illustrated embodiment of the invention the user interface presents the user with steps 80-92 as options from which the user can select, in other embodiments the user interface may operate in any other suitable manner. For example, some steps may occur automatically upon a triggering event, such as detection of the beginning of a transmission from a UAV. Also, menus may be organized in a hierarchical manner, as is common in computer user interfaces, with the selection of an option leading to the display of sub-options from which the user can then select. It should further be noted that although all of steps 80-92 are included in the illustrated embodiment for purposes of illustration, other embodiments of the invention may include only a subset of these steps or may include additional steps. In view of the teachings herein, persons skilled in the art to which the invention relates will readily be capable of providing suitable hardware and software elements to effect method steps 80-92 and other method steps that will occur to such persons in view of these teachings.

It will be apparent to those skilled in the art that various modifications and variations can be made to this invention without departing from the spirit or scope of the invention. For example, although in the exemplary embodiment of the invention described above the transmissions originate with an unmanned aerial vehicle, in other such embodiments they can originate with any other suitable source, such as an unmanned ground vehicle. Thus, it is intended that the present invention covers the modifications and variations of this invention provided that they come within the scope of any claims and their equivalents.

What is claimed is:

1. An imagery display system, comprising:
a wristwatch-like housing having means for attaching to a user's arm;
an unmanned vehicle (UV) data receiver; and
a display screen mounted in the housing and electronically coupled to the UV data receiver to display data received from a UV.

2. The system as claimed in claim 1, wherein the data received from the UV and displayed on the display screen includes UV video imagery.

3. The system as claimed in claim 1, wherein the UV data receiver is external to the housing and is electronically coupled to the display screen via a display communication link.

4. The system as claimed in claim 3, wherein the display communication link is wireless.

5. The system as claimed in claim 4, wherein the UV data receiver is disposed in a wearable unit having means for attaching to a user's body.

6. The system as claimed in claim 5, wherein the means for attaching to the user's body comprises means for attaching to a user's belt.

7. The system as claimed in claim 1, further comprising Global Positioning System (GPS) receiver electronics electronically coupled to the display to receive and decode location information from GPS satellites and display the location information on the display screen.

8. The system as claimed in claim 7, wherein the location information is combined with map information to display an indication of the location of the user with respect to a map.

9. The system as claimed in claim 8, wherein the data received from the UV includes information indicating the location of the UV, and the display screen displays an indication of the location of the UV with respect to a map.

10. The system as claimed in claim 1, further comprising a text-messaging transceiver electronically coupled to the display screen.

11. The system as claimed in claim 1, further comprising a digital camera mounted in the housing.

12. The system as claimed in claim 1, further comprising a wireless networking transceiver.

13. A wireless data network, comprising:
a plurality of imagery display systems, each comprising:
a wristwatch-like housing having means for attaching to a user's arm;
an unmanned vehicle (UV) data receiver; and
a display screen mounted in the housing and electronically coupled to the UV data receiver to display data received from a UV; and
a wireless networking transceiver to communicate data with other ones of the plurality of imagery display systems.

14. The wireless data network as claimed in claim 13, wherein each imagery display system further comprises a digital camera mounted in the housing and electronically coupled to the wireless networking transceiver to communicate video imagery with other ones of the plurality of imagery display systems.

15. The wireless data network as claimed in claim 13, wherein each imagery display system further comprises a text messaging user interface for communicating text messages with other ones of the plurality of imagery display systems.

16. A method for displaying imagery received from an unmanned aerial vehicle (UV) on a imagery display system, the method comprising the steps of:
wearing, on a user's wrist, at least a portion of the system having a display screen viewable by the user;
receiving imagery transmitted from a UV; and
displaying the imagery on the display screen.

17. The method as claimed in claim 16, further comprising the steps of:
receiving location information from GPS satellites;
combining the location information with map information; and
displaying an indication of the location of the user with respect to a map.

18. The method as claimed in claim 17, further comprising the steps of:
receiving information transmitted from the UV indicating the location of the UV;
combining the location information with pre-stored map information; and
displaying an indication of the location of the UV with respect to the map.

19. The method as claimed in claim 16, further comprising the step of capturing imagery with a camera of the imagery display system.

20. The method as claimed in claim 16, further comprising the step of wirelessly communicating text messages with other imagery display systems.
